(19) United States
(12) Patent Application Publication
(10) Pub. No.: US 2004/0144274 A1
(43) Pub. Date: Jul. 29, 2004

(54) SELF-INKING STAMP

(76) Inventors: Wolfgang Pichler, Wels (AT); Peter Zindl, Obertraun (AT)

Correspondence Address: Law Offices of Karl Hormann, 86 Sparks Street, Cambridge, MA, 02138-2216, US

(21) Appl. No.: 10/030,724

(22) PCT Filed: Apr. 12, 2001
(86) PCT No.: PCT/AT01/00110

(30) Foreign Application Priority Data
May 11, 2000 (AT) GM 349/2000

(51) Int. Cl. B41K 1/42

(52) U.S. Cl. 101/333

(57) ABSTRACT

Top-dyeing self-inking stamp with a bottom section (1) to be placed on a surface to be stamped, an ink pad arranged in a container (3) insertable for replacement into a receiving shaft (8), a flipping mechanism for a stamp platen arranged in the bottom section for reciprocal pivoting movement between the ink pad and a support frame (5) and an actuator upper section (6), the ink pad container being provided at its upper surface with at least one groove (7) extending in the insertion direction for from-fitting engagement by a rib (9) arrange at the upper surface of the receiving shaft.

The invention relates to a top dyeing self-inking stamp with a bottom section to be placed on a surface to be stamped, an ink pad arranged in a container adapted to be inserted for replacement into a receiving shaft, a flipping mechanism for a stamp platen disposed in the bottom section for flipping reciprocal movement and an actuator movable against the bias of a spring relative to the bottom section.

Such stamps are provided with ink pads which usually are inserted horizontally into a receiving shaft of the stamp. It has been found that ink pads of generally lower quality fabricated by third parties are being marketed as replacement ink pads which fit into the shaft designed for the original ink pad. This, however, leads to an overall reduction in the quality of the imprint and of the stamp and to the reputation of the product.

It is an object of the invention to structure the ink pad and the receiving shaft such that it is difficult and preferably impossible to insert third party pads. In accordance with the invention, this is accomplished by the ink pd container being provided in its upper surface with at least one groove extending in the insertion direction for form-fitting engagement by a rib disposed at the upper surface of the receiving shaft.

Preferably, several spaced grooves as well as several commensurately spaced ribs are provided.

In accordance with another embodiment of the invention the rib or ribs extend only across a portion of the length of the insertion stroke of the ink pad container.

Such a structure renders insertion of a non-fitting pad impossible.

In accordance with another preferred embodiment of the invention, the groove or grooves and the rib or ribs are of substantially semi-circular cross-section; they may, however, be of a different cross-section, e.g., triangular.

An embodiment of the invention will hereinafter be described in greater detail with reference to the drawing, in which:

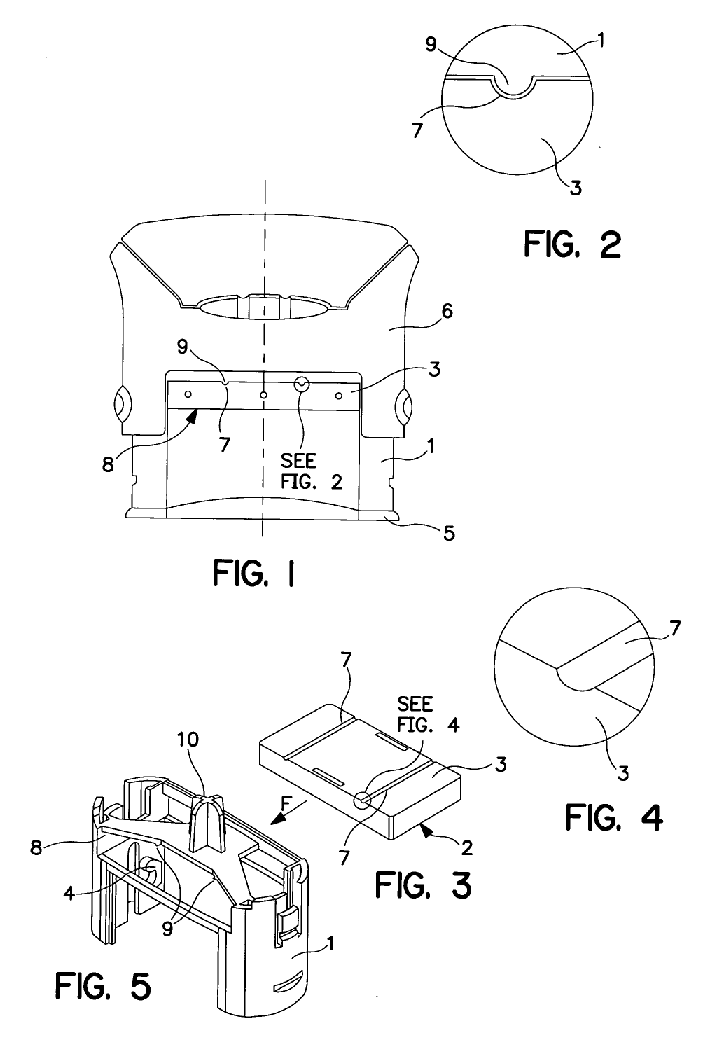

FIG. 1 is a view of the stamp in accordance with the invention;

FIG. 2 is a detail of FIG. 1;

FIG. 3 is a perspective view of an ink pad;

FIG. 4 is a detail if FIG. 2; and

FIG. 5 is a perspective view of the bottom section of the stamp.

The depicted self-inking stamp is provided with a bottom section 1 to be placed on a surface to be stamped, an ink pad 2 arranged in a container 3 which may slidingly be horizontally inserted in the direction of arrow F into a receiving shaft 8 of the bottom section 1. The bottom section 1 is provided with a flipping mechanism 4 for a stamp platen (not shown) reciprocally movable and pivotable between the ink pad 2 and a support frame 5. Furthermore, the stamp is provided with an actuator upper section 6 slidable relative to the bottom section 1 against the bias of a spring (not shown) seated on a spring support 10. The actuator 6 embraces the bottom section 1 and is connected therewith.

As shown in FIG. 3, the ink pad container 3 is provided at its upper surface, extending in the direction F of insertion, with two grooves 7 form-fittingly to be engaged by ribs 9 provided at the upper surface of the receiving shaft 8 and extending for only a portion of the length of insertion of the ink pad container 3. In the embodiment shown, the grooves 7 and the ribs 9 are of substantially semi-circular cross-section.

It is within the scope of the invention to provide more than two grooves 7, for instance, and, preferably, several appropriately spaced ribs 9.

It will be understood that within the concept of the invention the depicted embodiment may be altered in different ways, particularly as to number and shape of ribs and grooves.

1. Top dyeing self-inking stamp comprising a bottom section to be placed on a surface to be stamped, an ink pad arranged within a container insertable for replacement into a receiving shaft, a flipping mechanism for a stamp platen arranged in the bottom section for reciprocal pivotal movement between the ink pad and a support frame and an actuator upper section moveable against the bias of a spring relative to the bottom section, characterized by the fact that the ink pad container (3) is provided at its upper surface with at least one groove (7) extending in the direction of insertion for form-fitting engagement by a rib (9) arranged at the upper surface of the receiving shaft (8).

2. Self-inking stamp of claim 1, characterized by the fact that there are provided several grooves (7) and preferably also several ribs (9) appropriately spaced relative to each other.

3. Self-inking stamp of claim 1 or 2, characterized by the fact that the rib or ribs (9) extend only over a portion of the insertion length of the ink pad container (3).

4. Self-inking stamp of one of claims 1 to 3, characterized by the fact that the groove or grooves (7) and the rib or ribs (9) are of substantially semi-circular cross-section.
